(19) United States
(12) Patent Application Publication
(10) Pub. No.: US 2014/0007016 A1
(43) Pub. Date: Jan. 2, 2014

(54) PRODUCT FITTING DEVICE AND METHOD

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: LING LI, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/858,116

(22) Filed: Apr. 8, 2013

(30) Foreign Application Priority Data
Jun. 27, 2012 (CN) 2012102155811

(51) Int. Cl. G06Q 30/06; G06F 3/0481

(52) U.S. Cl. CPC G06Q 30/0623; G06F 3/04815
USPC 715/848

(57) ABSTRACT

A product fitting method applied in a product fitting device includes the following steps: selecting one 3D user model stored in the device; searching in an online store to find 3D product models satisfying a search condition of a product input by a user; displaying product information of the found 3D product models for the user to select; determining which body part of the selected 3D user model the selected 3D product model fits; identifying a feature part of the determined body part; computing the body characteristic data of the feature part of the selected 3D user model; scaling the selected 3D product model according to the body characteristic data to cause the scaled 3D product model to fit the selected 3D user model; combining the scaled 3D product model and the 3D user model to form a 3D image; and displaying the 3D image.

### BACKGROUND

1. Technical Field

The present disclosure relates to product fitting devices and particularly, to a product fitting device and a method for such a product fitting device.

2. Description of Related Art

Shopping over the Internet has become very popular. However, the disadvantage of shopping over the Internet is that buyers cannot easily determine whether a product such as a piece of clothing will look good on them because they cannot try it on before purchasing.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure.

Moreover, in the drawings, like reference numerals designate corresponding parts throughout the several views.

FIG. 1 is a block diagram of a product fitting device, in accordance with an exemplary embodiment.

FIG. 2 is a flowchart of a product fitting method, in accordance with an exemplary embodiment.

### DETAILED DESCRIPTION

Embodiments of the present disclosure will now be described in detail, with reference to the accompanying drawings.

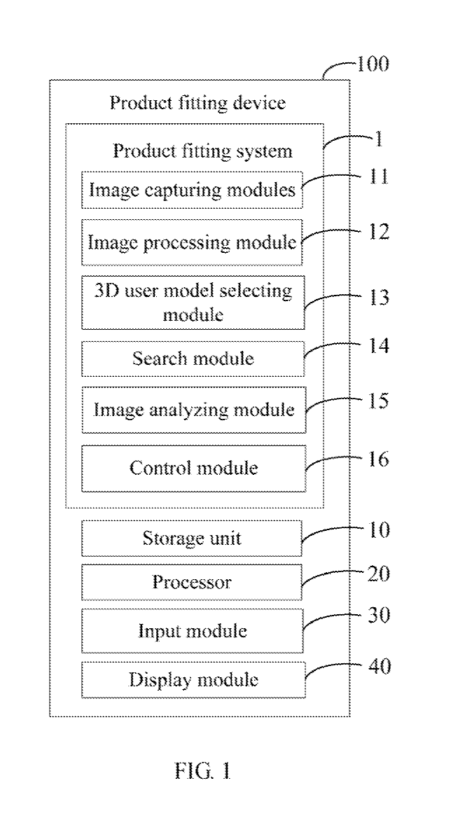

FIG. 1 is a block diagram of a product fitting device 100 according to an exemplary embodiment. The device 100, such as a mobile terminal or a tablet computer, includes a storage unit 10, a processor 20, an input unit 30, and a display unit 40. The storage unit 10 stores information of three-dimensional (3D) user model of at least one user.

The storage unit 10 further stores a product fitting system 1. The system 1 includes a variety of modules executed by the processor 20 to provide the functions of the system 1.

In the embodiment, the system 1 includes a pair of image capturing modules 11 and an image processing module 12. Each module of the pair of image capturing modules 11 simultaneously captures a two-dimensional (2D) image of the user from two different orientations. The image processing module 12 generates a 3D user model using the two 2D images, and then stores the generated 3D user model in the storage unit 10. In the embodiment, shooting orientations of the pair of the image capturing modules 11 can be adjusted, thus allowing the pair of image capturing modules 11 to capture 2D images of the user from different shooting orientations, and 3D user models that provide views from any direction can be accordingly generated by the image processing module 12.

In the embodiment, the system 1 further includes a 3D user model selecting module 13, a search module 14, an image analyzing module 15, and a control module 16.

The 3D user model selecting module 13 is to select one 3D user model from the storage unit 10 according to user input through the input unit 30.

The search module 14 is to search in an online store to find one or more 3D product models satisfying a search condition of a product input by the user through the input unit 30, and display product information of one or more found 3D product models on the display unit 40 for the user to select. The products can be a variety of commodities, such as wigs, glasses, and clothes, for example. The search condition of a product can be type, color, material, and price of the product.

The image analyzing module 15 determines a type of the 3D product model selected by the user, determines which body part of the selected 3D user model the selected 3D product model fits according to the determined type, identifies a feature part of the determined body part by for example, using recognition software known in the art. and computes the body characteristic data of the identified feature part of the selected 3D user model. For example, if the selected 3D product model is a model of a shirt which fits the upper body of a user, the image analyzing module 15 identifies the shoulders of the upper body, and a dimension from shoulder to shoulder of the selected 3D user model is thus computed.

The control module 16 scales the selected 3D product model according to the determined body characteristic data to cause the scaled 3D product model to fit the selected 3D user model. For example, if a 3D model of a shirt is selected, the shoulders dimension of the shirt model is scaled to be the same as those of the 3D user model. The control module 16 further combines the scaled 3D product model and the 3D user model to form a 3D image and displays the formed 3D image on the display unit 40, so that the user can judge whether he or she will look good wearing the product. In this embodiment, the control module 16 further rotates the formed 3D image in response to user input through the input unit 30 to allow the user to see how he or she looks wearing the product from different viewpoints.

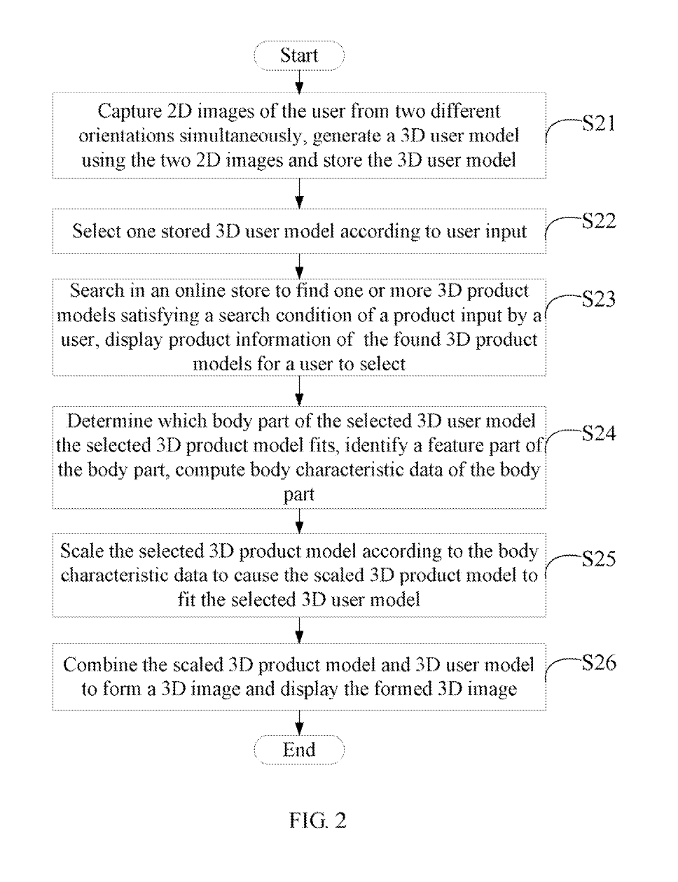

FIG. 2 is a schematic view showing a product fitting method in accordance with an exemplary embodiment.

In step S21, each of the pair of image capturing modules 11 simultaneously captures a two-dimensional (2D) image of the user from two different orientations, and the image processing module 12 generates the 3D user model using the two 2D images and stores the generated 3D user model in the storage unit 10.

In step S22, the 3D user model selecting module selects one 3D user model from the storage unit 10 according to user input through the input unit 30.

In step S23, the search module 14 searches in an online store to find one or more 3D product models satisfying a search condition of a product input by the user through the input unit 30, and displays product information of one or more found 3D product models on the display unit 40 for the user to select.

In step S24, the image analyzing module 15 determines a type of the 3D product model selected by the user, determines which body part of the selected 3D user model the selected 3D product model fits according to the determined type, identifies a feature of the determined body part, and computes the body characteristic data of the identified feature part of the selected 3D user model.

In step S25, the control module 16 scales the selected 3D product model according to the determined body characteristic data to cause the scaled 3D product model to fit the selected 3D user model.

In step S26, the control module 16 combines the scaled 3D product model and the 3D user model to form a 3D image, and displays the formed 3D image on the display unit 40, so that the user can judge whether he or she will look good wearing the product.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A product fitting device comprising:
an input unit;
a display unit;
a storage unit storing a plurality of modules and information of at least one 3D user model of at least one user; and
a processor configured to execute the plurality of modules, and the plurality of modules comprising:
a 3D user model selecting module to select one 3D user model from the storage unit according to user input through the input unit;
a search module to search in an online store to find one or more 3D product models satisfying a search condition of a product input by a user through the input unit, and display product information of one or more found 3D product models on the display unit for the user to select;
an image analyzing module to determine a type of the 3D product model selected by the user, determine which body part of the selected 3D user model the selected 3D product model fits according to the determined type, identify a feature part of the determined body part, and compute the body characteristic data of the identified feature part of the selected 3D user model; and
a control module to scale the selected 3D product model according to the determined body characteristic data to cause the scaled 3D product model to fit the selected 3D user model, combine the scaled 3D product model and the 3D user model to form a 3D image, and display the formed 3D image on the display unit.

2. The product fitting device as described in claim 1, wherein the plurality of modules further comprises a pair of image capturing modules and an image processing module, each of the pair of image capturing modules is configured to simultaneously capture a 2D image of the user from two different orientations, and the image processing module is configured to generate a 3D user model using the two 2D images, and then store the generated 3D user model in the storage unit.

3. The product fitting device as described in claim 2, wherein shooting directions of the pair of the image capturing modules is adjustable.

4. The product fitting device as described in claim 1, the control module is further configured to rotate the formed 3D image in response to user input through the input unit.

5. A product fitting system applied in a product fitting device storing information of 3D user model, the system comprising:
a 3D user model selecting module to select one 3D user model stored in the product fitting device according to user input through an input unit of the product fitting device;
a search module to search in an online store to find one or more 3D product models satisfying a search condition of a product input by a user through the input unit, and display product information of one or more found 3D product models on a display unit of the product fitting device for the user to select;
an image analyzing module to determine a type of the 3D product model selected by the user, determine which body part of the selected 3D user model the selected 3D product model fits according to the determined type, identify a feature part of the determined body part, and compute the body characteristic data of the identified feature part of the selected 3D user model; and
a control module to scale the selected 3D product model according to the determined body characteristic data to cause the scaled 3D product model to fit the selected 3D user model, combine the scaled 3D product model and the 3D user model to form a 3D image, and display the formed 3D image on the display unit.

6. The product fitting system as described in claim 5, further comprising a pair of image capturing modules and an image processing module, wherein each of the pair of image capturing modules is configured to simultaneously capture a 2D image of the user from two different orientations, and the image processing module is configured to generate a 3D user model using the two 2D images, and then store the generated 3D user model in the storage unit.

7. The product fitting system as described in claim 6, wherein shooting directions of the pair of the image capturing modules is adjustable.

8. The product fitting system as described in claim 5, the control module is further configured to rotate the formed 3D image in response to user input through the input unit.

9. A product fitting method applied in a product fitting device storing information of 3D user model, the method comprising:
selecting one 3D user model stored in the product fitting device according to user input through an input unit of the product fitting device;
searching in an online store to find one or more 3D product models satisfying a search condition of a product input by a user through the input unit, and displaying product information of one or more found 3D product models for the user to select;
determining a type of the 3D product model selected by the user;
determining which body part of the selected 3D user model the selected 3D product model fits according to the determined type;
identifying a feature part of the determined body part, and computing the body characteristic data of the identified feature part of the selected 3D user model;
scaling the selected 3D product model according to the determined body characteristic data to cause the scaled 3D product model to fit the selected 3D user model; and
combining the scaled 3D product model and the 3D user model to form a 3D image, and displaying the formed 3D image.
